(19) United States
(12) Patent Application Publication
(10) Pub. No.: US 2026/0010478 A1
(43) Pub. Date: Jan. 8, 2026

(54) CXL SWITCH SUPPORTING LOW LATENCY CACHE COHERENCE, CXL COMPUTING SYSTEM, AND OPERATING METHOD THEREOF

(71) Applicant: KOREA ADVANCED INSTITUTE OF SCIENCE AND TECHNOLOGY, Daejeon (KR)

(72) Inventors: Myoungsoo JUNG, Daejeon (KR); Miryeong KWON, Daejeon (KR); Sangwon LEE, Daejeon (KR); Donghyun GOUK, Daejeon (KR)

(21) Appl. No.: 19/184,128

(22) Filed: Apr. 21, 2025

(30) Foreign Application Priority Data
Jul. 8, 2024 (KR) 10-2024-0089925

(51) Int. Cl. G06F 12/0817; G06F 13/42

(52) U.S. Cl. CPC G06F 12/0828; G06F 13/4221; G06F 2212/621; G06F 2213/0026

(57) ABSTRACT

Disclosed is a CXL computing system including a compute express link (CXL)-enabled host CPU, CXL devices, and a CXL switch connecting the host CPU and the CXL devices. The CXL switch includes a switch coherence agent that manages cache coherence of the CXL devices connected to a lower layer.

### CROSS-REFERENCE TO RELATED APPLICATION

This application claims priority to and the benefit of Korean Patent Application No. 10-2024-0089925 filed in the Korean Intellectual Property Office on July 8, 2024, the entire contents of which are incorporated herein by reference.

### BACKGROUND

### (a) Field

The present disclosure related to a compute express link (CXL).

### (b) Description of the Related Art

Compute express link (CXL) is an open industry standard that enables multiple heterogeneous devices share a unified memory space through cache coherent interconnect. A CXL based host computer (host CPU) and CXL devices can be connected through a CXL switch.

The CXL switch consists an upstream port (USP) connected to a root port (RP) of the host computer, and a downstream port (DSP) connected to the CXL device. The CXL switch can be categorized into a single-VCS switch and a multiple-VCS switch based on the number of virtual CXL switches (VCSs) they support. The single-VCS switch has one upstream port and one or more downstream ports, and the multiple-VCS switch has one or more upstream ports and one or more downstream ports.

The CXL switch primarily functions to relay messages to a target device or address. Accordingly, when a type-1 device or a type-2 device using a CXL.cache protocol accesses a host managed device memory (HDM) of another device connected to the CXL switch, data reads or writes occur continuously via a cache coherence engine in a host computer. In this case, the CXL message is delivered through a total of three CXL links: the CXL link between the type-1 device or the type-2 device and the CXL switch, the CXL link between the CXL switch and the host computer, and the CXL link between the CXL switch and a device having the HDM. This results in increased latency for data read/write operations. For applications with a lot of data sharing between devices connected to the CXL switch, the data access latency can significantly impact performance such as a processing speed.

### SUMMARY

The present disclosure relates to a CXL switch supporting low latency cache coherence, a CXL computing system including the same, and an operating method thereof.

The present disclosure relates to a CXL switch including a switch coherence agent (SCOH).

Some exemplary embodiments of the present disclosure provide a CXL computing system including: a compute express link (CXL)-enabled host CPU; CXL devices; and a CXL switch connecting the host CPU and the CXL devices. The CXL switch includes a switch coherence agent that manages cache coherence of the CXL devices connected to a lower layer.

The switch coherence agent may be implemented to manage cache coherence between the host CPU and each CXL device.

The switch coherence agent may be implemented to support an access of the host CPU to a CXL device memory while maintaining the cache coherence.

The switch coherence agent may be implemented as a snoop-based cache coherence algorithm or a directory-based cache coherence algorithm.

The CXL switch may be implemented to receive a CXL message including a cache line request from a specific CXL device connected to a lower layer, check whether there is at least one target device having a requested cache line in a cache among the CXL devices and the host CPU, and acquire data from the target device to deliver the data to the specific CXL device when there is the target device.

The CXL switch may be implemented to access a CXL device memory related to the requested cache line when the target device having the requested cache line in a cache is not present, and deliver data read from the CXL device memory to the specific CXL device.

The CXL switch may be implemented to access the CXL device memory through a CXL.mem protocol.

Some exemplary embodiments of the present disclosure provide an operating method of a CXL switch connected to a compute express link (CXL)-enabled host CPU and CXL devices. The operating method includes: receiving a CXL message including a cache line request from a specific CXL device connected to a lower layer; checking whether there is at least one target device having a requested cache line in a cache among the CXL devices and the host CPU; and acquiring data from the target device to delivering the data to the specific CXL device when there is the target device.

The operating method may further include: accessing a CXL device memory related to the requested cache line when the target device having the requested cache line in a cache is not present; and delivering data read from the CXL device memory to the specific CXL device.

The accessing the CXL device memory may include accessing the CXL device memory through a CXL.mem protocol.

The CXL switch may include a switch coherence agent that manages cache coherence of CXL devices connected to a lower layer.

Yet another exemplary embodiment of the present disclosure provides a CXL switch implemented to connect a compute express link (CXL)-enabled host CPU and CXL devices, and manage cache coherence of the CXL devices connected to a lower layer through a switch coherence agent.

The switch coherence agent may be implemented to manage cache coherence between the host CPU and each CXL device.

The switch coherence agent may be implemented to support an access of the host CPU to a CXL device memory while maintaining the cache coherence.

The switch coherence agent may be implemented as a snoop-based cache coherence algorithm or a directory-based cache coherence algorithm.

The switch coherence agent may be implemented to receive a CXL message including a cache line request from a specific CXL device connected to a lower layer, check whether there is at least one target device having a requested cache line in a cache among the CXL devices and the host CPU, and acquire data from the target device to deliver the data to the specific CXL device.

The switch coherence agent may be implemented to access a CXL device memory related to the requested cache line when the target device having the requested cache line in a cache is not present, and deliver data read from the CXL device memory to the specific CXL device.

The switch coherence agent may be implemented to access the CXL device memory through a CXL.mem protocol.

According to the present disclosure, since a CXL switch manages cache coherence in the middle of an upper host CPU and lower CXL devices, a cache coherence domain can be efficiently managed.

According to the present disclosure, the number of CXL links through which a message for cache coherence management should go can be reduced through a switch coherence agent (SCOH) implemented in the CXL switch, and as a result, a data access latency can be shortened.

According to the present disclosure, in various applications implemented through data sharing between devices connected to the CXL switch, the data access latency is shortened, thereby enhancing a performance such as an execution speed, etc.

### BRIEF DESCRIPTION OF THE DRAWINGS

FIG. 1 is a diagram exemplarily describing a structure of a CXL computing system according to an exemplary embodiment.

FIG. 2 is a diagram describing a CXL switch supporting low-latency cache coherence according to an exemplary embodiment.

FIG. 3 is a diagram describing a CXL switch interconnect for a scientific application according to an exemplary embodiment.

FIG. 4 is a flowchart describing a method for supporting cache coherence of a CXL switch according to an exemplary embodiment.

### DETAILED DESCRIPTION OF THE EMBODIMENTS

In the following detailed description, only certain exemplary embodiments of the present disclosure have been shown and described, simply by way of illustration. However, the present disclosure can be variously implemented and is not limited to the following exemplary embodiments. In addition, in the drawings, the drawings and description are to be regarded as illustrative in nature and not restrictive. Like reference numerals designate like elements throughout the specification.

In the description, reference numerals and names are arbitrarily shown for understanding and ease of description, but the present disclosure is not limited thereto.

In the description, unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

In the description, the expression described by the singular can be interpreted as a singular or plurality, unless an explicit expression such as "one" or "single" is used. Terms including an ordinary number, such as first and second, are used for describing various constituent elements, but the constituent elements are not limited by the terms. The terms are used to discriminate one constituent element from another component.

In the flowchart described with reference to the drawings, the order of operations may be changed, multiple operations may be merged, or any operation may be divided, and a specific operation may not be performed.

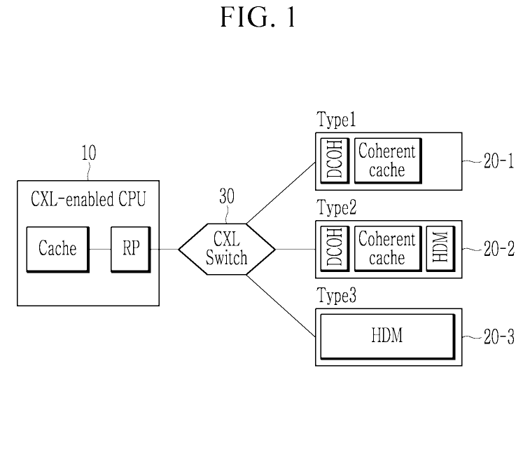

FIG. 1 is a diagram exemplarily describing a structure of a CXL computing system according to an exemplary embodiment.

Referring to FIG. 1, compute express link (CXL) is an open industry standard that makes multiple heterogeneous devices share a memory space through cache coherent interconnect. A CXL-enabled host CPU 10 and CXL devices (20-1, 20-2, 20-3, …) may be connected through a CXL switch 30. Here, the CPU as an example of a computing device may be implemented as other types of computing devices.

The CXL supports three subprotocols, i.e., CXL.io, CXL.cache, and CXL.mem.

CXL.io is a protocol required for all types of hardware, and is used for communication between a host and a CXL device. The CXL device may expose a device register to an HPA as a memory-mapped IO (MMIO) by using CXL.io. The host CPU 10 may discover the CXL device or configure required values by using CXL.io.

CXL.cache is a protocol used for the CXL device to implement a coherent cache by sending a memory request to the host. When CXL.cache is used, the CXL devices 20-1 and 20-2 may include a cache coherent domain to store data in an HPA space in a cache inside the device. According to CXL 3.0, cache line states inside the CXL device are managed by a device coherency engine (DCOH). Further, the host CPU 10 may be embedded with a cache coherence engine such as a cache/home agent (CHA) in order to place all devices in the cache coherence domain managed by the CXL.

CXL.mem is a protocol for the host to access a memory by sending the memory request to the CXL device. Internal memories of the CXL devices 20-2 and 20-3 as host-managed device memories (HDMs) may be exposed to a physical memory map of the host by using CXL.mem. The host CPU 10 may access the memories of the remote CXL devices 20-2 and 20-3 through a load/store instruction.

Types of CXL devices are defined according to a method for coupling a subprotocol.

The CXL type-1 device 20-1 uses CXL.io and CXL.cache for an entire cache coherence function.

The CXL type-2 device 20-2 uses CXL.io, CXL.cache, and CXL.mem. The host may communicate with the CXL type-2 device 20-2 by using CXL.io, and perform coherent cache implementation and HDM access with the device by using CXL.cache and CXL.mem. The host may manage the HDM by using cache coherent load/store instructions.

The CXL type-3 device 20-3 uses CXL.io and CXL.mem. The CXL type-3 device 20-3 may be used for a non-acceleration device using only an HDM having no processing component and managed by the host.

The CXL switch 30 connects the host CPU 10, and various types of CXL devices (20-1, 20-2, 20-3, …) through an upstream port (USP) connected to a root port (RP) of the host CPU 10, and a downstream port (DSP) connected to the CXL device. The CXL switch 30 may be implemented as a virtual CXL switch (VCS), and constituted by one or more upstream ports and one or more downstream ports.

As such, according to CXL 3.0, the CXL switch 30 supports only a function of delivering the message through the upstream port and the downstream port, and the host CPU 10 manages cache coherence. Accordingly, when the type-1 device 20-1 or the type-2 device 20-2 using the CXL.cache protocol accesses an HDM of another CXL device (e.g., reference numeral 20-3) connected to the CXL switch 30, data is continuously read or written via the cache coherence engine in the host CPU 10. In this case, the CXL message should be delivered through a total of three links, i.e., a link between the type-1 device 20-1/the type-2 device 20-2, and the CXL switch 30, a link between the CXL switch 30 and the host CPU 10, and a link between the CXL switch 30 and the device 20-3 having the HDM. Accordingly, a latency time required for data read/write becomes longer by the number of CXL links through which should be passed for the cache coherence during data sharing between the devices connected to the CXL switch. Next, a CXL switch which solves this is described.

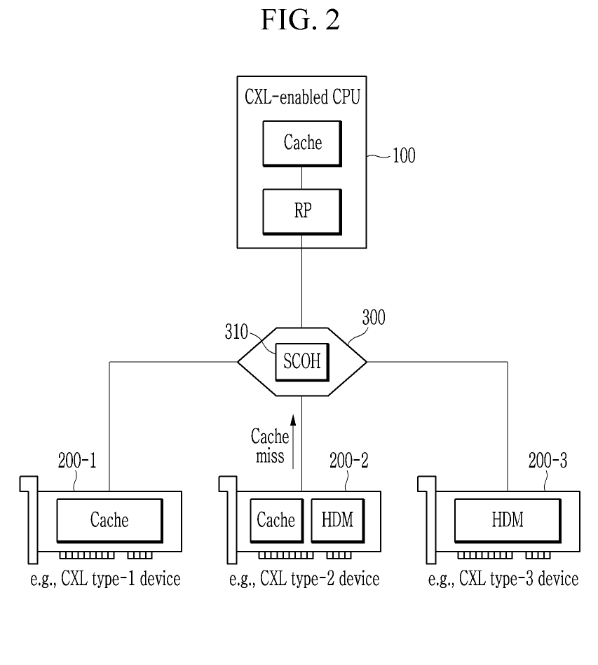

FIG. 2 is a diagram describing a CXL switch supporting low-latency cache coherence according to an exemplary embodiment.

Referring to FIG. 2, the CXL computing system may include a CXL-enabled host CPU 100, CXL devices (200-1, 200-2, …), and a CXL switch 300 connecting the CXL-enabled host CPU 100, and the CXL devices (200-1, 200-2, …). Here, the host CPU implemented in the host device may be an example of the computing device, and may be replaced with other types of computing devices as necessary.

The CXL switch 300 may route CXL packets inserted into the upstream port or the downstream port to a corresponding port according to an internal routing table. Further, the CXL switch 300 includes a switch coherence agent (SCOH) 310 that manages cache coherence of CXL devices connected to a lower layer. The CXL switch 300 may manage cache coherence between the host CPU and each CXL device.

The SCOH 310 may support the cache coherence of the CXL devices connected to the lower layer similarly to the cache coherence engine of the host CPU 100. The SCOH 310 may conserve the cache coherence between the host CPU 100 and the CXL device, and support the access of the CPU 100 to the corresponding HDM even when the host CPU 100 accesses the HDM of the CXL device.

The SCOH 310 may be implemented as various schemes of cache coherence algorithms, and for example, may be implemented as a snoop-based cache coherence algorithm or a directory-based cache coherence algorithm. When the SCOH 310 is implemented as the directory-based cache coherence algorithm, the CXL switch 300 may know a target device having a cache line of the HDM of the lower CXL device, and know whether the host CPU 100 has the corresponding cache line. Accordingly, the CXL switch 300 may send a cache coherence message only to the target device or the host CPU 100 to further shorten a data access latency compared to the snoop-based algorithm.

For example, it is assumed that a cache miss occurs in the CXL device (e.g., the CXL type-2 device) 200-2 connected to the lower layer of the CXL switch 300. Then, the CXL device 200-2 delivers a CXL message (CXL flit) for requesting a cache line in which the cache miss occurs to the SCOH 310 of the CXL switch 300 through the CXL link.

The SCOH 310 checks whether there is a device having the requested cache line among devices included in a cache coherence domain. That is, the SCOH 310 checks whether the host CPU 100 has the requested cache line, and whether another CXL device, for example, the CXL type-1 device 200-1 or another CXL type-2 device has the requested cache line. When the host CPU 100 or other CXL devices have the requested cache line in a cache, the SCOH 310 may acquire cache line data from the corresponding cache, and deliver the acquired cache line data to the CXL device 200-2 which requests the cache line data.

Meanwhile, the SCOH 310 may not be able to obtain the requested cache line from the cache of the host CPU 100 or other CXL devices. Then, the SCOH 310 may read the data by accessing a CXL device memory related to the cache line, e.g., an HDM of the CXL type-3 device 200-3, and deliver the read data to the CXL device 200-2 which requests the read data, by using CXL.mem.

As such, since the CXL switch 300 manages cache coherence in the middle of an upper host CPU and lower CXL devices through the SCOH 310, a cache coherence domain may be efficiently managed.

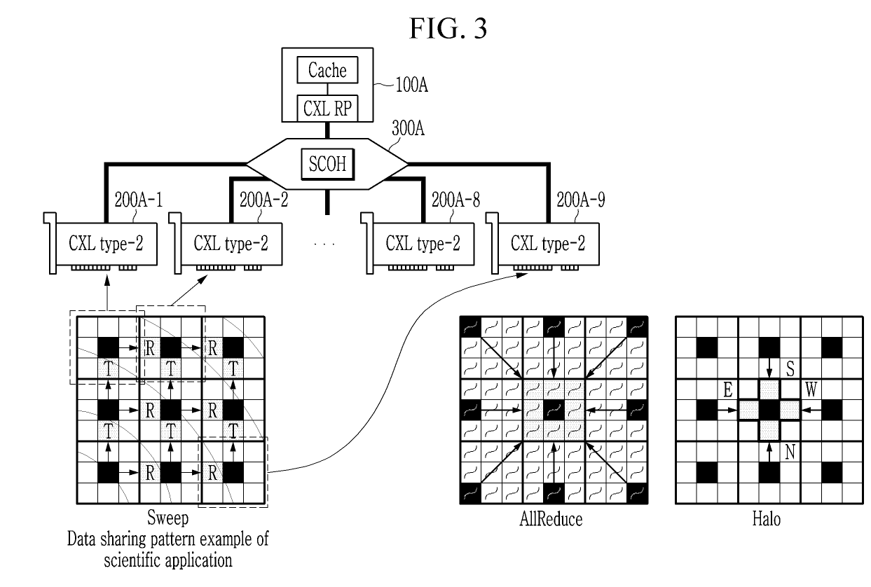

FIG. 3 is a diagram describing a CXL switch interconnect for a scientific application according to an exemplary embodiment.

Referring to FIG. 3, it is assumed that there are nine CXL type-2 devices 200A-1, 200A-2, …, 200A-8, 200A-9 on a lower layer of a CXL switch 300A. Since the CXL devices are enabled to share data through the CXL switch 300, the CXL devices may be placed by a 3 x 3 grid layout corresponding to a data sharing pattern of a scientific application. Small 3 x 3 grid cells which are present a single grid placed in each CXL device may be an HDM space allocated for application by each CXL device.

As a representative data sharing pattern of scientific applications a Sweep pattern, an AllReduce pattern, and a Halo pattern are taken as an example. The Sweep pattern is a data sharing pattern that simulates a wavefront, and a representative application is a radiation transport. The AllReduce pattern is a data sharing pattern for constituting N separated experimental environment, and the representative application is a single chain in mean field (SCMF). The Halo pattern is a sharing pattern utilizing neighboring data that covers a surrounding like a halo, and the representative application is hydrodynamics and thermal conduction.

It is assumed that each CXL device updates data of a small black grid cell every iteration in the process of iterating the same operation of the scientific application. In order to update the data of the small black grid cell, each CXL device should share data updated by neighboring CXL devices in previous iteration. To this end, each CXL device allocates the remaining HDM space other than the small black grid cell for data sharing.

When the scientific application is executed by using the CXL switch 300A including the switch coherence agent (SCOH), a latency by data sharing between CXL devices 200A-1, 200A-2, …, 200A-8, 200A-9 connected to the CXL switch 300A may be significantly shortened compared to the existing CXL switch 30. By using the CXL switch 300A that supports the cache coherence, an execution time may be significantly shortened in a scientific application in which data sharing and exchange often occur.

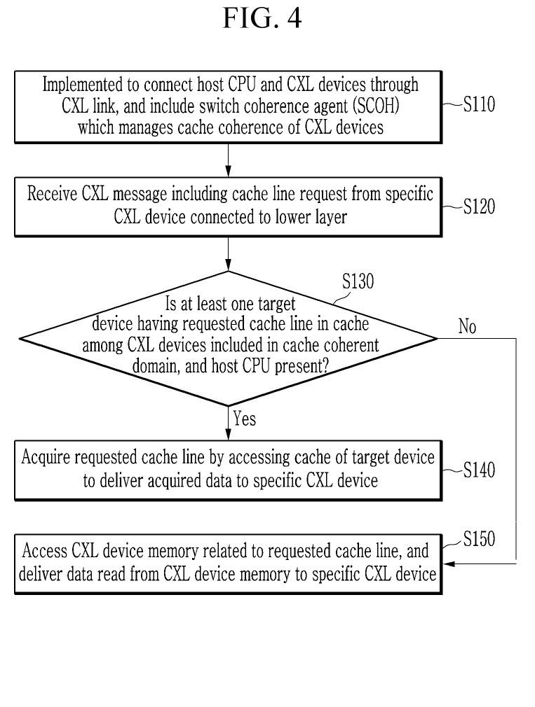

FIG. 4 is a flowchart describing a method for supporting cache coherence of a CXL switch according to an exemplary embodiment.

Referring to FIG. 4, the CXL switch 300 is implemented to connect the host CPU and the CXL devices through the CXL link, and to include the switch coherence agent (SCOH) which manages the cache coherence of the CXL devices (S110). The switch coherence agent (SCOH) may be implemented as, for example, a snoop-based cache coherence algorithm or a directory-based cache coherence algorithm. The switch coherence agent (SCOH) may support the cache coherence of the CXL devices connected to the lower layer similarly to the cache coherence engine of the host CPU. The switch coherence agent (SCOH) may maintain the cache coherence between the host CPU and the CXL device, and support the access of the host CPU to the corresponding HDM even when the host CPU accesses the HDM of the CXL device.

The CXL switch 300 receives a CXL message (CXL flit) including a cache line request from a specific CXL device (e.g., CXL type-2 device) connected to the lower layer (S120).

The CXL switch 300 checks whether there is at least one target device having the requested cache line in a cache among the CXL devices included in the cache coherence domain and the host CPU by using the cache coherence algorithm (S130). The CXL switch 300 may check whether the host CPU 100 has the requested cache line, and whether the lower CXL type-1 device/CXL type-2 device has the requested cache line.

When there is a target device having the requested cache line in the cache, the CXL switch 300 acquires the requested cache line by accessing the cache of the target device, and delivers acquired data to a specific CXL device (S140).

Meanwhile, when the CXL switch 300 does not acquire the requested cache line from the caches of the CXL devices included in the cache coherence domain, and the host CPU, the CXL switch 300 accesses the CXL device memory (HDM) related to the requested cache line, and delivers data read by the CXL device memory to the specific CXL device (S150). The CXL switch 300 may access the device memory by using CXL.mem, and read data from the device memory through a read instruction or write data to the device memory through a store instruction. The CXL switch 300 may transmit a memory request for the cache line in which the cache miss occurs to the CXL device memory.

As such, according to the present disclosure, since a CXL switch manages cache coherence in the middle of an upper host CPU and lower CXL devices, a cache coherence domain can be efficiently managed.

According to the present disclosure, the number of CXL links through which a message for cache coherence management should go can be reduced through a switch coherence agent (SCOH) implemented in the CXL switch, and as a result, a data access latency can be shortened.

According to the present disclosure, in various applications implemented through data sharing between devices connected to the CXL switch, the data access latency is shortened, thereby enhancing a performance such as an execution speed, etc.

The exemplary embodiments of the present disclosure described above are not implemented only through the apparatus and the method and can be implemented through a program which realizes a function corresponding to a configuration of the exemplary embodiments of the present disclosure or a recording medium having the program recorded therein.

While the present disclosure has been described in connection with what is presently considered to be practical exemplary embodiments, it is to be understood that the present disclosure is not limited to the disclosed exemplary embodiments, but, on the contrary, is intended to cover various modifications and equivalent arrangements included within the spirit and scope of the appended claims.

What is claimed is:

1. A CXL computing system comprising:
a compute express link (CXL)-enabled host CPU;
CXL devices; and
a CXL switch connecting the host CPU and the CXL devices,
wherein the CXL switch includes a switch coherence agent that manages cache coherence of the CXL devices connected to a lower layer.

2. The CXL computing system of claim 1, wherein the switch coherence agent is implemented to manage cache coherence between the host CPU and each CXL device.

3. The CXL computing system of claim 2, wherein the switch coherence agent is implemented to support an access of the host CPU to a CXL device memory while maintaining the cache coherence.

4. The CXL computing system of claim 1, wherein the switch coherence agent is implemented as a snoop-based cache coherence algorithm or a directory-based cache coherence algorithm.

5. The CXL computing system of claim 1, wherein the CXL switch is implemented to
receive a CXL message including a cache line request from a specific CXL device connected to a lower layer,
check whether there is at least one target device having a requested cache line in a cache among the CXL devices and the host CPU, and
acquire data from the target device to deliver the data to the specific CXL device when there is the target device.

6. The CXL computing system of claim 5, wherein the CXL switch is implemented to
access a CXL device memory related to the requested cache line when the target device having the requested cache line in a cache is not present, and
deliver data read from the CXL device memory to the specific CXL device.

7. The CXL computing system of claim 6, wherein the CXL switch is implemented to access the CXL device memory through a CXL.mem protocol.

8. An operating method of a CXL switch connected to a compute express link (CXL)-enabled host CPU and CXL devices, comprising:
receiving a CXL message including a cache line request from a specific CXL device connected to a lower layer;
checking whether there is at least one target device having a requested cache line in a cache among the CXL devices and the host CPU; and
acquiring data from the target device to deliver the data to the specific CXL device when there is the target device.

9. The operating method of claim 8, further comprising:
accessing a CXL device memory related to the requested cache line when the target device having the requested cache line in a cache is not present; and
delivering data read from the CXL device memory to the specific CXL device.

10. The operating method of claim 9, wherein the accessing to the CXL device memory comprises accessing the CXL device memory through a CXL.mem protocol.

11. The operating method of claim 8, wherein the CXL switch includes a switch coherence agent that manages cache coherence of CXL devices connected to a lower layer.

12. A CXL switch implemented to connect a compute express link (CXL)-enabled host CPU and CXL devices, and manage cache coherence of the CXL devices connected to a lower layer through a switch coherence agent.

13. The CXL switch of claim 12, wherein the switch coherence agent is implemented to manage cache coherence between the host CPU and each CXL device.

14. The CXL switch of claim 12, wherein the switch coherence agent is implemented to support an access of the host CPU to a CXL device memory while maintaining the cache coherence.

15. The CXL switch of claim 12, wherein the switch coherence agent is implemented as a snoop-based cache coherence algorithm or a directory-based cache coherence algorithm.

16. The CXL switch of claim 12, wherein the switch coherence agent is implemented to
receive a CXL message including a cache line request from a specific CXL device connected to a lower layer,
check whether there is at least one target device having a requested cache line in a cache among the CXL devices and the host CPU, and
acquire data from the target device to deliver the data to the specific CXL device.

17. The CXL switch of claim 16, wherein the switch coherence agent is implemented to
access a CXL device memory related to the requested cache line when there is the target device having the requested cache line in a cache is not present, and
deliver data read from the CXL device memory to the specific CXL device.

18. The CXL switch of claim 17, wherein the switch coherence agent is implemented to access the CXL device memory through a CXL.mem protocol.
